(19) United States
(12) Patent Application Publication
(10) Pub. No.: US 2024/0323046 A1
(43) Pub. Date: Sep. 26, 2024

(54) METHOD OF INSTALLING HOME NETWORK SYSTEM HAVING VIRTUAL PRIVATE NETWORK WITHOUT OPERATION STOP AND HOME NETWORK SYSTEM THEREFOR

(71) Applicant: Security Platform Inc., Seongnam-si (KR)

(72) Inventors: Jeong Su SONG, Ansan-si (KR); Youn Ho LEE, Ansan-si (KR); Hyun Kook YEO, Gwangju-si (KR); Yeon Hwa KONG, Seoul (KR); Min Sung LEE, Guri-si (KR)

(21) Appl. No.: 18/610,027

(22) Filed: Mar. 19, 2024

(30) Foreign Application Priority Data
Mar. 20, 2023 (KR) 10-2023-0036188

(51) Int. Cl. H04L 12/46

(52) U.S. Cl. CPC H04L 12/462

(57) ABSTRACT

A method of installing a home network system applied to an apartment building composed of a plurality of unit spaces includes: providing a home server connected to a network, a plurality of home network devices installed for unit spaces, respectively, a VPN server installed between the home server and the home network devices, and VPN gateways individually installed for the home network devices between the home network devices and the VPN server, wherein the VPN gateways each include a first bridge terminal for communication with a corresponding home network device, a first intermediate communication terminal for communication with the VPN server, and an operation mode alteration detector, and the first bridge terminal includes a first end communication interface and a TAP interface; directly connecting the first end communication interface and the first intermediate communication terminal of the first bridge terminal until receiving a virtual private network start signal from the VPN server or the home server by means of the operation mode alteration detector; and connecting the first TAP interface and the first intermediate communication terminal of the first bridge terminal after receiving a virtual private network start signal from the VPN server or the home server by means of the operation mode alteration detector.

### CROSS-REFERENCE TO RELATED APPLICATIONS

The present application claims priority to Korean Patent Applications No. 10-2023-0036188, filed Mar. 20, 2023, the entire contents of which are incorporated herein for all purposes by this reference.

### BACKGROUND

### Technical Field

The present disclosure relates to an installation method of adding a virtual private network to a home network system without operation stop when implementing network separation in a home network system using a virtual private network (VPN), and a home network system for the method.

### Description of the Related Art

FIG. 1 is a diagram illustrating a home network system for an apartment building of the related art.

Referring to FIG. 1, a home network system for an apartment building of the related art may include a home server 10, a plurality of home network devices 11˜13, and a back bone 20. The home network devices 11˜13 such as a wall pad can be provided for respective households and the back bone 20 can be a passage through which a packet passes by binding the home network devices 11˜13 installed at respective households in a network.

In the home network system of the related art, the home network device of one household can be directly connected with the home network device of another household as long as the IP is known. The households can control the entrance door, lights, heating/cooling, ventilation, cameras, etc. through the home network devices 11˜13, respectively, but when the home network devices 11˜13 are hacked, the problem that outsiders can acquire sensitive information may be brought up. Further, as IoT devices are generalized, such IoT devices can be connected to wall pads or other home network devices, but the danger of damage due to hacking of IoT devices through these paths is greatly increasing, and accordingly, network separation among households is increasingly required.

Network separation in an apartment building means the technology of separating networks for respective households. In apartment buildings such as a multiplex housing and a row house building, all of the units in the complex can be connected to one network and there is the danger of spread of damage to other households when one household is hacked. In order to prevent this problem, it is possible to cut the connections between households by separating networks between the households.

Network separation can be classified into two types of physical network separation and logical network separation.

‘Physical network separation’ is a technology of physically separating networks by constructing both of an external network and an internal network. Physical network separation has the defect that it has high security, but requires a high cost for construction and it is difficult to change the environment after designing.

‘Logical network separation’ is a technology of separating networks through a virtualization technology. Representatively, there is a virtual private network (VPN) that constructs virtual tunnels (data transmission passages) connected only to respective households in a network connecting a server and the households. Logical network separation does not require physical installation of many networks, so the construction cost is low, but there is the inconvenience that it is impossible to use existing server and wall pads as they are in order to use a VPN and it is required to newly change VPN setting not only in a server, but the wall pad of each household in order to form virtual private networks.

An “Image monitoring system and method” that uses a VPN has been disclosed in Korean Patent No. 10-0920171. The document describes that it is possible to improve communication security between a client and a server by performing authentication and communication using a VPN in a monitoring system in an apartment building. This is common logical network separation, but has the defect that it is required to install a separate authentication server and existing modules before the VPN technology is applied cannot be used as they are as a client module and a server module.

A “Smart wall pad performing self security monitoring and operation method of the same” has been disclosed in Korean Patent No. 10-2498603. The wall pad includes a monitoring module, a notification module, a storage module, etc. for security and can check by itself whether it has been attacked. This has the defect that the wall pad has to be replaced with new one and wall pads of the related art cannot be used.

Further, in order to implement logical network separation in a home network system that has been installed already, the home network system of an apartment building has to stop all of services and a large-scale construction is required. Even though a new home network system is installed, a complicated condition that virtual private networks have to be simultaneously installed may be applied. However, it is substantially impossible to simultaneously replace wall pads or change the setting thereof in all of the household of an apartment building.

This may be because of the amount of work, but the members of households may be absent or it is difficult to equally adjust work time among households, so even small-scale construction takes a week or several months in many cases.

Since a network system is used for a lot of work in an apartment building, there are many problems in that it is difficult to stop all of services of a network system in an apartment building while finishing installing and setting virtual private networks.

### SUMMARY

The present disclosure provides a method of installing a home network system that can implement a network separation technology even without replacing a home server and wall pads or changing the setting thereof before network separation and can devise various measures in accordance with the progress of installation even without installing VPN gateways simultaneously for all of households when applying logical network separation to a home network system for an apartment building.

According to an exemplary embodiment of the present disclosure for achieving the objectives of the present disclosure described above, a method of installing a home network system applied to an apartment building composed of a plurality of unit spaces may include: providing a home server connected to a network, a plurality of home network devices installed for unit spaces, respectively, a VPN server installed between the home server and the home network devices, and VPN gateways individually installed for the home network devices between the home network devices and the VPN server, wherein the VPN gateways each include a first bridge terminal communication with a corresponding home network device, a first intermediate communication terminal for communication with the VPN server, and an operation mode alteration detector, and the first bridge terminal includes a first end communication interface and a TAP interface; directly connecting the first end communication interface and the first intermediate communication terminal of the first bridge terminal until receiving a virtual private network start signal from the VPN server or the home server by means of the operation mode alteration detector; and connecting the first TAP interface and the first intermediate communication terminal of the first bridge terminal after receiving a virtual private network start signal from the VPN server or the home server by means of the operation mode alteration detector.

Since the operation mode alteration detector directly connects the first end communication interface and the first intermediate communication terminal until a virtual private network is started, a home network system of the related art can be used. When preparation for operating the virtual private networks for all of households is finished, the VPN server or the home server can transmit a signal for starting to operate the virtual private networks and the operation mode alteration detector of the VPN gateway can make a signal passing through the first bridge terminal be processed through the first end communication interface and the TAP interface.

The VPN gateway may further include a local packet analyzer or a network setting unit and an automatic IP of the VPN gateway may be configurated at the early stage or in the unit of predetermined time.

The first end communication interface and the first intermediate communication terminal may have a same communication interface. The first end communication interface and the first intermediate communication terminal may use communication interfaces used in an existing network and may include the types including UTP, FTP, STP, S-STP, S-FTP cables, etc.

A VPN gateway may be installed in the unit space together with the home network device. Since a virtual private network is for network separation, it is preferable that a VPN gateway is installed in a unit space, that is, a household of an apartment building. Since a VPN gateway should be installed in a unit space, there is an avoidable problem that virtual private networks using VPN gateways cannot be prepared to be simultaneously started.

The home network system may include a separate back bone for connecting the home server and the home network devices and, when virtual private networks are started, the VPN server may make communication between the home network devices and the home server be processed using a back bone gateway in priority to the back bone.

The back bone gateway can process information about the IP of a back bone in priority to the actual back bone in communication with the home network devices through the VPN gateways, and signals going to the home server from the home network devices or signals going to the home network devices from the home server can be transmitted to the VPN server or the VPN gateways through the VPN tunnels without passing through the actual back bone.

According to an exemplary embodiment of the present disclosure for achieving the objectives of the present disclosure described above, a home network system applied to an apartment building composed of a plurality of unit spaces may include: a home server connected to a network, a plurality of home network devices installed for unit spaces, respectively, a VPN server installed between the home server and the home network devices, and VPN gateways individually installed for the home network devices between the home network devices and the VPN server, wherein the VPN gateways each may include a first bridge terminal communication with a corresponding home network device, a first intermediate communication terminal for communication with the VPN server, and an operation mode alteration detector, and the first bridge terminal may include a first end communication interface and a TAP interface.

When the VPN gateways are installed in only some of unit spaces, virtual private networks cannot be immediately started, and only when VPN gateways are installed in all of unit spaces, virtual private networks can be operated.

Accordingly, even though a VPN gateway is installed in a unit space, the operation mode alteration detector can directly connect the first end communication interface and the first intermediate communication terminal of the first bridge terminal until receiving a virtual private network start signal from the VPN server or the home server.

The operation mode alteration detector can connect the first TAP interface and the first intermediate communication terminal of the first bridge terminal after receiving a virtual private network start signal from the VPN server or the home server.

The home network system may include a back bone for connecting the home server and the home network devices and, when virtual private networks are started, the VPN server may process communication between the home network devices and the home server using a back bone gateway in priority to the back bone.

In the present disclosure, an apartment building may be understood as a building or a structure that includes a plurality of unit spaces, can be expanded to various concepts including not only a multiplex housing and a row house building, but also an office building, a factory, etc., and can be applied to physically separated structures as well.

According to a home network system and a method of installing the home network system of the present disclosure, it is possible to overcome the problem that it is impossible to simultaneously install VPN gateways in all of unit spaces and it is possible to devise various measures in accordance with the progress of installation.

There was a problem that a network system has to be stopped until VPN gateways are installed in all of households in the related art, but the home network system of the present disclosure can provide fundamental surfaces without stopping operation while operating an existing network system until a virtual private network is started.

The home network system to which the VPN gateway of the present disclosure has been applied can additionally apply logical network separation to an existing home network system, and in this process, it is possible to implement a network separation technology without replacing an existing home server or home network devices and changing the setting and it is possible to smoothly perform construction.

Since the home network system of the present disclosure enables a manager to maintain an existing management system as it is before network separation, there is the advantage that a manager can directly apply the home network system without new training or upgrading a manual in the same way before and after a virtual private network is started.

### BRIEF DESCRIPTION OF THE DRAWINGS

FIG. 1 is a diagram illustrating a home network system for an apartment building of the related art;

FIG. 2 is a diagram illustrating a home network system and a VPN gateway to which a network separation technology according to an embodiment of the present disclosure has been applied;

FIG. 3 is a diagram illustrating the functions of a VPN gateway and a VPN server in the home network system of FIG. 2;

FIG. 4 is a diagram illustrating the functions of the VPN gateway of FIG. 2 and an operation mode alteration detector.

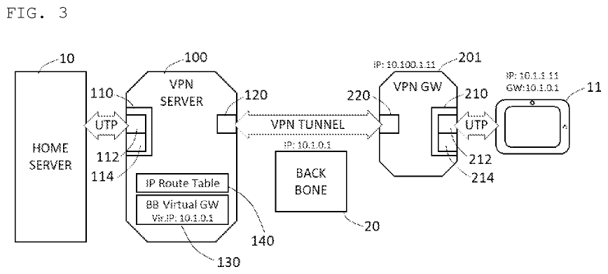

### DETAILED DESCRIPTION

Hereafter, preferred embodiments of the present disclosure will be described in detail with reference to the accompanying drawings, but the present disclosure is not limited or restricted to the embodiments. For reference, the same reference numerals substantially indicate the same components in the description, it is possible to refer to the matters shown in other figures under this rule, and matters that are determined as being apparent or repetitive to those skilled in the art may be omitted.

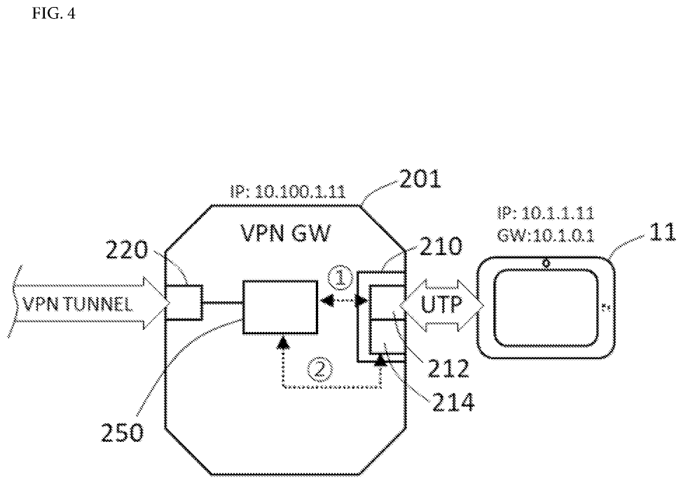

FIG. 2 is a diagram illustrating a home network system and a VPN gateway to which a network separation technology according to an embodiment of the present disclosure has been applied, FIG. 3 is a diagram illustrating the functions of a VPN gateway and a VPN server in the home network system of FIG. 2, and FIG. 4 is a diagram illustrating the functions of the VPN gateway of FIG. 2 and an operation mode alteration detector.

Referring to FIGS. 2 to 4, a VPN gateway 201 according to the embodiment can be applied to construction of a virtual private network for network separation in a home network system for an apartment building. The entire configuration of a home network system for an apartment building can be implemented by additionally installing a VPN server 100 and VPN gateways 201˜203 on a network with a home server 10, a plurality of home network devices 11˜13, and a back bone 20 installed on the network.

The VPN gateways 201˜203 may be additionally installed to the home network devices 11˜13 installed for respective households and the VPN server 100 may be installed between the VPN gateways 201˜203 and the home server 10. The VPN gateways 201˜203 and the VPN server 100 can be installed on an existing network and there is the advantage that it is possible to form a virtual private network for logical network separation while installing them on an existing network.

There is also an example of additionally forming a virtual private network in a home network system in the related art. However, a method of additionally installing a virtual private network in the related art requires replacement of home network devices and the equipment of a home server or the setting for each household for a VPN, but the virtual private network according to the embodiment is different in that it is possible to achieve network separation only by installing the VPN gateways 201˜203 and the VPN server 100 on a network without changing the setting of the home network devices 11˜13 and the home server 10.

To this end, the VPN gateways 201˜203 may include a first bridge terminal 210 for communication with the home network devices 11˜13 and a first relay communication terminal 220 for communication with the VPN server 100. Further, the VPN server 100 may include a second bridge terminal 110 for communication with the home server 10 and a second intermediate communication terminal 120 for communication with the VPN gateways 201˜203.

The first bridge terminal 210 may include a first end communication interface 212 and a first TAP interface 214 and the second bridge terminal 110 may include a second end communication interface 112 and a second TAP interface 114. The first end communication interface 212 and the second end communication interface 112 can use communication interfaces that are used on the existing network, and can use a UTP cable type that is generally used can be used. Further, as the end communication interfaces, the types that use FTP, STP, S-STP, S-FTP cables, etc. can be used.

In the first bridge terminal 210 and the second bridge terminal 110, respectively, the first TAP interface 214 and the second TAP interface 114 may be added between communication interfaces according to UTP cable type. The TAP interfaces can use an interface that provides a data link layer of TCP/IP layers to a network interface to be able to control a network packet, and in the embodiment, the TAP interfaces can be used in linkage with end communication interfaces such as a UTP.

The first intermediate communication terminal 220 and the second intermediate communication terminal 120 that connect the VPN gateways 201˜203 and the VPN server 100 can also use the type that uses a UTP cable that was installed before, and can use an existing network installed in an existing home network system.

However, when virtual private networks are started, the first bridge terminal 210 and the second bridge terminal 110 include the first TAP interface 214 and the second TAP interface 114, respectively, whereby the VPN gateways 201˜203 and the VPN server 100 can form VPN terminals.

As in FIG. 3, VPN tunnels connecting the intermediate communication interfaces can be formed between the VPN gateways 201˜203 and the VPN server 100. The VPN gateways 201˜203 can form a network-separated state from the VPN server 100 through the VPN tunnels.

The VPN server 100 includes a back bone virtual gateway 130 that can replace the actual back bone 20 and the back bone virtual gateway 130 can perform processing in priority to the actual back bone 20 in communication through the VPN tunnels. To this end, the back bone virtual gateway 130 can be given a virtual IP (10.1.0.1) that is the same as the IP, for example, (10.1.0.1) of the actual back bone 20, and can transmit signals, which are transmitted from the home network devices 11˜13 or the home server 10, to the home server 10 or other home network devices not through the actual backbone 20 by preferentially processing signals corresponding to the IP (10.1.0.1) of a back bone. As a result, the home network devices 11˜13 and the home server 10 both can use the existing network as if there is the actual backbone 20, and even though a virtual private network is additionally formed, it is not required to change the setting of the home network devices 11˜13 or the home server 10.

Since it is not required to change existing setting, it is possible to achieve logical network separation using a virtual private network without replacing or upgrading equipment only by installing the VPN gateways 201˜203 and the VPN server 100 according to the present disclosure even in old home network systems in which a virtual private network essentially cannot be installed.

Further, it is possible to satisfy the network separation rule describing that home network devices and a home server designed and manufactured for an existing home network system have to use virtual private networks while maintaining the existing design, so the companies that manufacture and install home network devices and a home server also can use the existing equipment without developing new equipment.

The back bone virtual gateway 130 can process information corresponding to the IP, for example, (10.1.0.1), of a back bone in priority to the actual back bone 20 in communication with the home network devices 11˜13 through the VPN gateways 201˜203, and the information may not be transmitted to the actual back bone 20. That is, signals going to the home server 10 from the home network devices 11˜13 or signals going to the home network devices 11˜13 from the home server 10 can be transmitted therebetween while detouring through the VPN tunnels without passing through the actual back bone 20.

The information about the IP of the back bone 20 may be defined as a plurality of items other than (10.1.0.1), and similar to the case in which the actual back bone 20 process signals for a plurality of IPs, the back bone virtual gateway 130 according to the embodiment can also process signals for a plurality of IPs as a substitute.

A worker can manually input the IP information of a back bone that is input to the back bone virtual gateway 130 in the embodiment while additionally installing the VPN gateways 201˜203 and the VPN server 100.

The VPN server 100 may include an IP route table 140 that stores the IPs of the home network devices 11˜13, MAC addresses, the IPs of the VPN gateways 201˜203 individually connected to the home network devices 11˜13, etc.

When receiving a signal corresponding to a specific home network device 11˜13 from the home server 10, the VPN server 100 can search for the information of the VPN gateway 201˜203 corresponding to the home network device 11˜13 by referring to the IP route table 140 and can transmit the signal to the VPN gateway 201˜203. For example, when a signal that is transmitted from the home server 10 corresponds to the IP information (10.1.1.11) of a specific home network device 11, it is possible to search for the IP information (10.100.1.11) of a matched VPN gateway 201 through the IP route table 140 and can transmit the signal to the VPN gateway 201.

The IP route table 140 may also be manually input, but, depending on cases, it is possible to receive and store automatically assigned IPs from the VPN gateways 201˜203 in the initial operation, and even after the initial operation, it is possible to update the IPs of home network devices, MAC addresses, the IPs of VPN gateways, etc. in the unit of predetermined time.

However, such virtual private networks for network separation have to satisfy the condition that installation of all of the VPN gateways 201˜203 of unit spaces have to be finished. However, in order to implement logical network separation in a home network system that has been installed already, the home network system of an apartment building has to stop all of services and a large-scale construction is required.

However, it is substantially impossible to install the VPN gateways 201˜203 of all of unit spaces of an apartment building, and the members of households may be absent or it may be difficult to equally adjust work time among households in many cases.

Referring to FIG. 4, in order to solve this problem, the VPN gateways 201˜203 may include an operation mode alteration detector 250 that controls connection between the first bridge terminal 210 and the first intermediate communication terminal 220.

The first bridge terminal 210 may be configured using the first end communication interface 212 and the first TAP interface 214, and the first end communication interface 212 and the first intermediate communication terminal 220 may use UTP, FTP, STP, S-STP, and S-FTP cable types that have been installed already. Accordingly, the operation mode alteration detector 250 can directly connect the first end communication interface 212 and the first intermediate communication terminal 220 of the first bridge terminal 210 until it receives a virtual private network start signal from the VPN server 100 such that the existing network system is used as it is without a VPN tunnel (see path \textcircled{1}).

Then, when receiving a virtual private network start signal from the VPN server 100, the operation mode alteration detector 250 can connect the first TAP interface 214 and the first intermediate communication terminal 220 of the first bridge terminal 210 such that a virtual private network is operated through a VPN tunnel (see path \textcircled{2}).

Though not shown, when a virtual private network is operated, the VPN gateway 201 may perform a process of automatically configurating an IP. For example, the VPN gateway 201 may include a local packet analyzer for analyzing a packet that is transmitted from or received to the home network device 11 and a network setting unit automatically creating an IP of the VPN gateway 201 using the IP of the home network device 11 acquired by the local packet analyzer.

Assuming that an IP is generally configured in 32 bits, the network setting unit can create an IP of a VPN gateway such that the lower 16 bits of the IP of the VPN gateway are the same as the lower 16 bits of the IP of a home network device. Depending on cases, the network setting unit may create an IP of a VPN gateway such that lower 24 bits of the IP of the gateway are the same as the lower 24 bits of the IP of a home network device.

The local packet analyzer analyzes an ARP packet that is transmitted from an adjacent home network device 11, thereby being able to automatically acquire the IP (10.1.1.11) of the individually installed home network device 11.

An Address Resolution Protocol (ARP) packet is a protocol for taking mapping information between a physical MAC address and a logical IP address and the local packet analyzer 230 can check the IP information of the matched home network devices 11˜13 through ARP packet analysis.

When the IP (10.1.1.11) of the home network device 11 is specified, the network setting unit can generate an IP of a VPN gateway as (10.100.1.11) such that the lower 16 bits of the IP of the VPN gateway are the same as the lower 16 bits of the home network device 11. For reference, the lower 16 bits of an IP may correspond to the latter two numbers of four numbers (0˜255) constituting the IP.

The VPN gateways 201˜203 can configurate their IPs by automatically referring to the IPs of the home network devices 11˜13 and the IP route table 140 of the VPN server 100 can combine and store the automatically configurated IPs of the VPN gateways 201˜203, the IPs of the home network devices 11˜13, MAC addresses, etc.

Although exemplary embodiments of the present disclosure were described above with reference to the drawings, it should be understood that the present disclosure may be changed and modified in various ways by those skilled in the art without departing from the spirit and scope of the present disclosure described in claims.

### REFERENCES

10: home server
11, 12, 13: home network devices
20: back bone
100: VPN server
110: second bridge terminal
120: second intermediate communication terminal
130: back bone virtual gateway
201, 202, 203: VPN gateways
210: first bridge terminal
220: first intermediate communication terminal
250: operation mode alteration detector

What is claimed is:

1. A method of installing a home network system applied to an apartment building composed of a plurality of unit spaces, the method comprising:
providing a home server connected to a network, a plurality of home network devices installed for unit spaces, respectively, a VPN server installed between the home server and the home network devices, and VPN gateways individually installed for the home network devices between the home network devices and the VPN server, wherein the VPN gateways each include a first bridge terminal for communication with a corresponding home network device, a first intermediate communication terminal for communication with the VPN server, and an operation mode alteration detector, and the first bridge terminal includes a first end communication interface and a TAP interface;
directly connecting the first end communication interface and the first intermediate communication terminal of the first bridge terminal until receiving a virtual private network start signal from the VPN server or the home server by means of the operation mode alteration detector; and
connecting the first TAP interface and the first intermediate communication terminal of the first bridge terminal after receiving a virtual private network start signal from the VPN server or the home server by means of the operation mode alteration detector.

2. The method of claim 1, wherein the first end communication interface and the first intermediate communication terminal have a same communication interface.

3. The method of claim 1, wherein the VPN gateway is installed in the unit space together with the home network device.

4. The method of claim 1, wherein the home network system includes a separate back bone for connecting the home server and the home network devices and, when virtual private networks are started, the VPN server makes communication between the home network devices and the home server be processed using a back bone gateway in priority to the back bone.

5. A home network system applied to an apartment building composed of a plurality of unit spaces, the home network system comprising a home server connected to a network, a plurality of home network devices installed for unit spaces, respectively, a VPN server installed between the home server and the home network devices, and VPN gateways individually installed for the home network devices between the home network devices and the VPN server,
wherein the VPN gateways each include a first bridge terminal for communication with a corresponding home network device, a first intermediate communication terminal for communication with the VPN server, and an operation mode alteration detector,
the first bridge terminal includes a first end communication interface and a TAP interface,
the operation mode alteration detector directly connects the first end communication interface and the first intermediate communication terminal of the first bridge terminal until receiving a virtual private network start signal from the VPN server or the home server, and
the operation mode alteration detector connects the first TAP interface and the first intermediate communication terminal of the first bridge terminal after receiving a virtual private network start signal from the VPN server or the home server.

6. The home network system of claim 5, wherein the first end communication interface and the first intermediate communication terminal have a same communication interface.

7. The home network system of claim 5, wherein the VPN gateway is installed in the unit space together with the home network device.

8. The home network system of claim 5, wherein the home network system includes a separate back bone for connecting the home server and the home network devices and, when virtual private networks are started, the VPN server processes communication between the home network devices and the home server using a back bone gateway in priority to the back bone.
